(19) United States
(12) Patent Application Publication
(10) Pub. No.: US 2005/0171814 A1
(43) Pub. Date: Aug. 4, 2005

(54) Examination management system

(75) Inventors: Masafumi Kobayashi, Sagamihara-shi (JP); Shinichi Omori, Tokyo (JP); Ryoichi Hosoya, Ichikawa-shi (JP); Hiroyuki Araki, Tokyo (JP); Nobuaki Matsubara, Saitama-shi (JP); Hideki Yasuda, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, TOKYO (JP)

(21) Appl. No.: 11/000,613

(22) Filed: Dec. 1, 2004

(30) Foreign Application Priority Data
Dec. 2, 2003 (JP) 2003-403701

(51) Int. Cl. G06F 17/60

(52) U.S. Cl. 705/2

(57) ABSTRACT

An examination management system according to the present invention compares an examining information relating to a predetermined examination with an examining target information corresponding to the examination, when the examination is conducted. If a predetermined condition is met, an input of the matter as the result of the comparison is permitted. When the matter is input, the matter is recorded.

### CROSS-REFERENCE TO RELATED APPLICATION

This application claims benefits of Japanese Application No. 2003-403701 filed in Japan on Dec. 2, 2003, the contents of which are incorporated by this reference.

### BACKGROUND OF THE INVENTION

1. Field of the Invention

The present invention relates to an examination management system which manages the medical examination.

2. Description of the Related Art

Japanese Unexamined Patent Application Publication No. 2002-73615 discloses a conventional system which enables the input and reference of information in accordance with a working flow of the endoscope examination. According to the conventional art, conducting information on the examination can be inputted and the inputted conducting information can be secondarily used.

Incidentally, in the examining operation of the endoscope examination, information generated in the medical action is not sufficiently secondarily used, and medical experts cannot clearly grasp the efficiency and improvement of medical action. That is, if one examination is the same type of examination with the same examining time, the examining time varies depending on factors including the examining experience or technique of doctors and the patient state and therefore the time factor for examination is not grasped.

### SUMMARY OF THE INVENTION

Briefly, in an examination management system according to the present invention, upon conducting a predetermined examination, an examining time for the examination is compared with an examining target time corresponding to the examination. When the examining time is over the examining target time, the input of a reason of examination-time-limit-over is permitted. Further, when the reason is inputted, the reason is recorded.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE DRAWINGS

FIG. 1 is a block diagram showing the structure of an endoscope examination management system according to the most preferable embodiment of the present invention;

FIG. 2 is a diagram showing the software structure of the endoscope examination management system according to the embodiment;

FIG. 3 is a diagram showing start and end screens of the system which is developed in the endoscope examination management system according to the embodiment;

FIG. 4 is a diagram showing the structure of tables/masters which are managed in a database in a server in the endoscope examination management system according to the embodiment;

FIG. 5 is a diagram showing a main screen for examination which is developed in the endoscope examination management system according to the embodiment;

FIG. 6 is a diagram showing a yet-to-be shot list screen which is developed in the endoscope examination management system according to the embodiment;

FIG. 7 is a flowchart showing an examining flow in the endoscope examination management system according to the embodiment;

FIG. 8 is a diagram showing a shooting screen which is developed in the endoscope examination management system according to the embodiment;

FIG. 9 is a diagram showing a screen of an examination-time-limit-over reason which is developed in the endoscope examination management system according to the embodiment;

FIG. 10 is a flowchart showing the shooting operation in the endoscope examination management system according to the embodiment;

FIG. 11 is a diagram showing a statistics and history screen which is developed in the endoscope examination management system according to the embodiment;

FIG. 12 is a diagram showing a list screen of the examination-time-limit-over reason which is developed in the endoscope examination management system according to the embodiment;

FIG. 13 is a diagram showing a management function screen which is developed in the endoscope examination management system according to the embodiment; and

FIG. 14 is a flowchart for explaining the flow of estimating a factor of an examination-time-limit-over in the endoscope examination management system according to the embodiment.

### DESCRIPTION OF THE PREFERRED EMBODIMENTS

Hereinbelow, a description is given of a preferable embodiment with reference to the drawings.

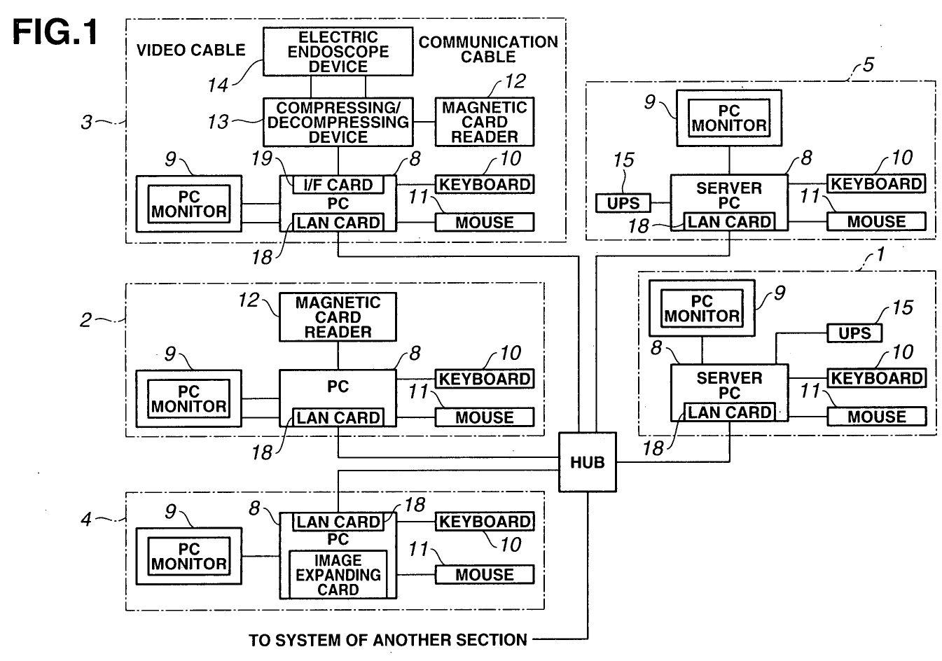

FIG. 1 is a block diagram showing the structure of an endoscope examination management system according to the most preferable embodiment of the present invention.

Mainly, the endoscope examining system comprises: a GW (gateway) 1 which exchanges data to another section in a hospital; a receiving terminal 2 which receives the examination; an input/examining terminal 3 which performs the examination; a search terminal 4 which displays and inputs an image and various information; and a server 5 which records data. The devices are connected by a network (LAN) distributed by a HUB 7.

Further, the devices have, as the basic structure, a personal computer 8, a PC monitor 9, a keyboard 10, and a mouse 11, and are connected to the network via a LAN card 18 provided for the personal computer 8.

The GW 1 has a UPS (uninterruptible power supply) 15 in addition to the basic structure, thus responding to the uninterruptible power supply. The receiving terminal 2 has a magnetic card reader 12 in addition to the basic structure. Further, the receiving terminal 2 is arranged at the reception desk or the like in the section to be used for the reception of the examination.

The input/examining terminal 3 comprises the magnetic card reader 12 and a compressing/decompressing device 13, in addition to the basic structure. The compressing/decompressing device 13 is connected to an electric endoscope device 14 via a video cable and a communication cable. The compressing/decompressing device 13 is connected to the personal computer 8 via an I/F card 19 arranged in the personal computer 8. The input/examining terminal 3 is used in the examination and therefore is arranged in an examination room.

The search terminal 4 has only the basic structure, and is arranged in a conference room or the like because it is mainly used for conference operation. The server 5 has the basic structure and further has the UPS 15 which responds to the uninterruptible power supply.

Although not shown in detail, the electric endoscope device 14 is similar to a general electric endoscope device and has an electric endoscope and a processor device for processing and outputting a video signal. The electric endoscope comprises a long inserting portion which is inserted in the body cavity and an operating portion arranged at the rear end of the inserting portion. The operating portion has a release switch for instructing the release operation, and the pressing operation of the release switch enables the image to be recorded.

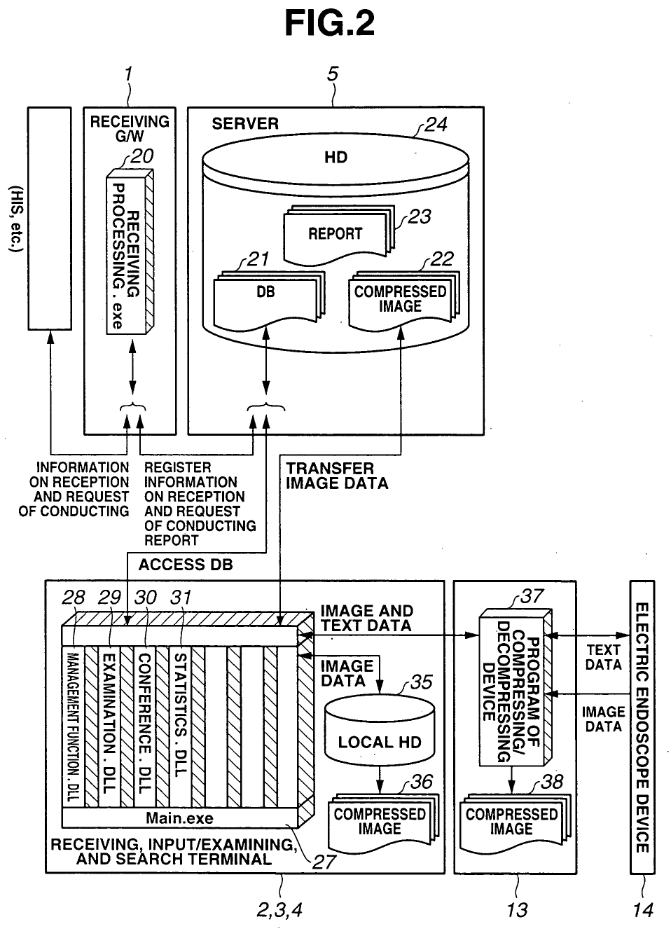

FIG. 2 is a diagram showing the software structure of the endoscope examination management system.

Various application software and databases are installed and are operated in the hard disks in the devices. GW application software 20 is operated on the GW 1.

A database 21 is operated on a hard disk 24 of the server 5. Further, the hard disk 24 records and stores a compressed image 22 which is picked-up by the input/examining terminal 3 and report information 23 for examination.

Software structure of the receiving terminal 2, input/examining terminal 3, and search terminal 4 is common thereamong. Main application software 27 is operated on the receiving terminal 2, input/examining terminal 3, and search terminal 4. The main application software 27 mainly comprises: an examination DLL (dynamic link library) 29; a conference DLL 30; statistics and history DLL 31; and a management function DLL 28. A hard disk 35 temporarily stores a compressed image 36.

As mentioned above, since the software structure of the receiving terminal 2, input/examining terminal 3, and search terminal 4 is common, the using purposes thereof vary depending on the installing place. However, unlike the receiving terminal 2 and search terminal 4, the compressing/decompressing device 13 for compressing/decompressing the image is connected only to the input/examining terminal 3 and the image pick-up operation is possible in the examination in the input/examining terminal 3. A compressing/decompressing device program 37 is operated on the compressing/decompressing device 13 and a compressed image 38 is temporarily stored in a memory in the compressing/decompressing device 13. The compressing/decompressing device 13 is connected to the electric endoscope device 14.

Next, a description is given of the operation of the endoscope examination management system. First, a description is given of information on the examination and the type of information which is managed by the system. The information managed by the system mainly has the following types of 1 to 4.

1. Patient Information

Patient Basic Information

This is information for specifying one patient, and includes “patient ID”, “name”, “date of birth”, “sex”, and the like. The “patient ID” is a number, uniquely corresponding to the patient for the purpose of identifying the patient.

Patient Profile Information

This is information indicating the characteristics and state of the patient, and includes “blood type”, “height/weight”, “allergy”, “disability”, “infection”, “disorder and notices”, “specimen examining result”, “premedication information”, and the like.

2. Examination Request Information

This is information on an examining request (order) in the case of examining an order to an endoscope section from another diagnostic section. Specifically, order key information (“order number”, “ordering date”, etc.), request side information (“request section name”, “request doctor name”, “request date”, etc.), order information (“request disease name”, “examining purpose”, “examination type”, “examining item”, “examined portion”, “comment”, “scheme image”, etc.), examination reservation information (“examining date”, “conducting time”, etc.). This information is sent to the system of section from an HIS (hospital information system). The order key information uniquely specifies one examining order.

3. Examination Conducting Information (Accounting Information)

This is information on examination conducting content, and includes “conducting date”, “conducting member”, “conducting place”, “manual”, “drug”, “equipment”, and the like. The information on the conducted “manual” and the used “drug” and “equipment” is used for accounting. This is sent to the HIS from the system of the endoscope section, and is processed by an HIS accounting system.

4. Examining Result Information (Report and Report Information)

This is information on the examining result, corresponding to a report for the examining request, and includes “report date”, “reporter”, “diagnosis”, “findings”, “treatment”, “comment”, “notes and instruction after examination”, “image”, “scheme image”, and the like. This information is referred to by a medical image filing system in the endoscope section, and is sent to the HIS from the system, thereby enabling referring to in the systems of the sections. Therefore, the examining result (report) of the section for ordering the examination is referred to.

Next, the transition of functional screens will be described.

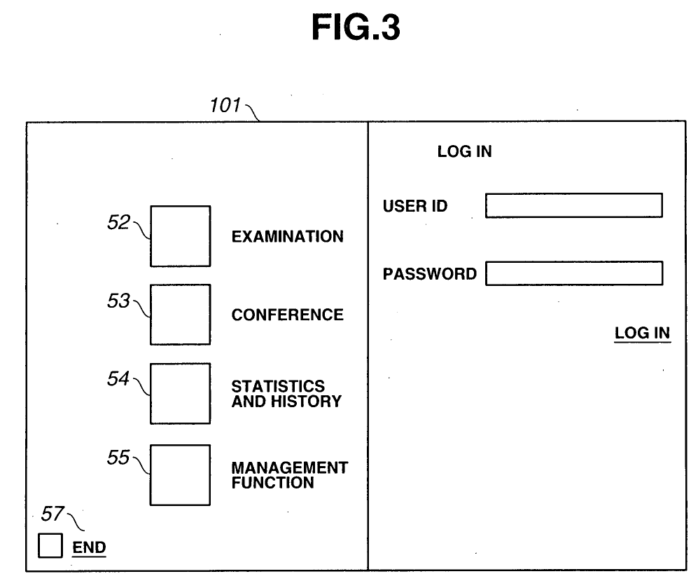

On a system start/end screen 101 shown in FIG. 3, an examination icon 52, a conference icon 53, a statistics and history icon 54, and a management function icon 55 are selected, corresponding to the DLLs 28 to 31 in the main application software 27. Further, a user ID and a password are inputted for log in. Then, the functions start.

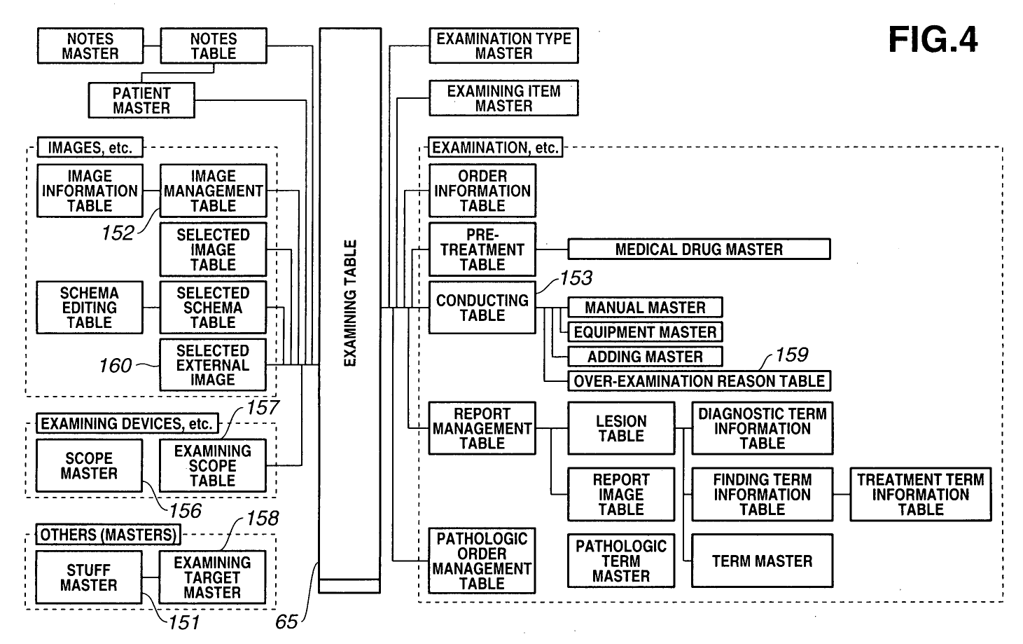

FIG. 4 shows the structure of tables/masters managed by the database 21 in the server 5. The user ID and the password are managed on a stuff master 151. The inputted user ID and password are compared with the managed ones and, if they match each other, the user is identified and the functions start. The user ID is not selectively inputted by a combo box or the like, but is directly inputted, and the troublesomeness of selection is improved. On the system start/end screen 101, an end button 57 (refer to FIG. 3) is selected, thereby enabling ending the system.

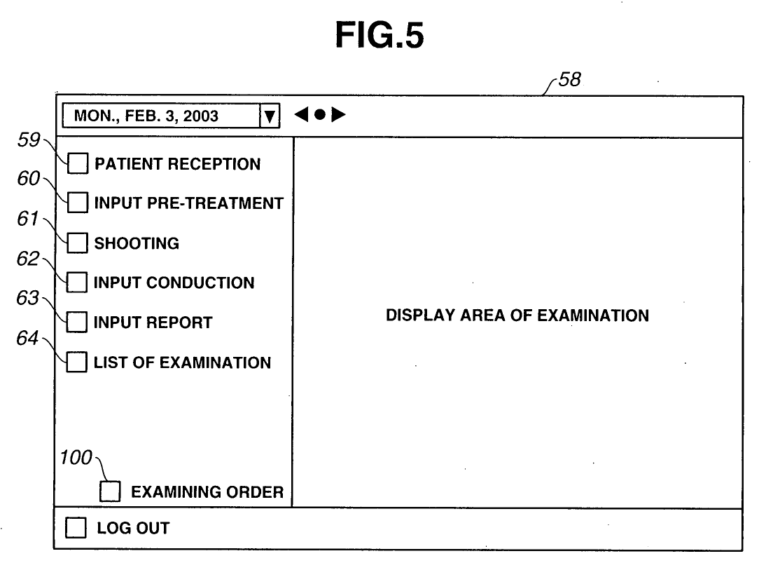

FIG. 5 is a diagram showing the start of a main screen 58 for examination by selecting the examination icon 52. Icons corresponding the examinations are arranged on the left of screen, and are selected, thereby enabling starting the screens. The main screen 58 for examination includes: a patient reception icon 59; a pre-treatment input icon 60; a shooting icon 61; a conduct and input icon 62; a report input icon 63; an examination list icon 64; and an examination order button 100.

<Shooting>

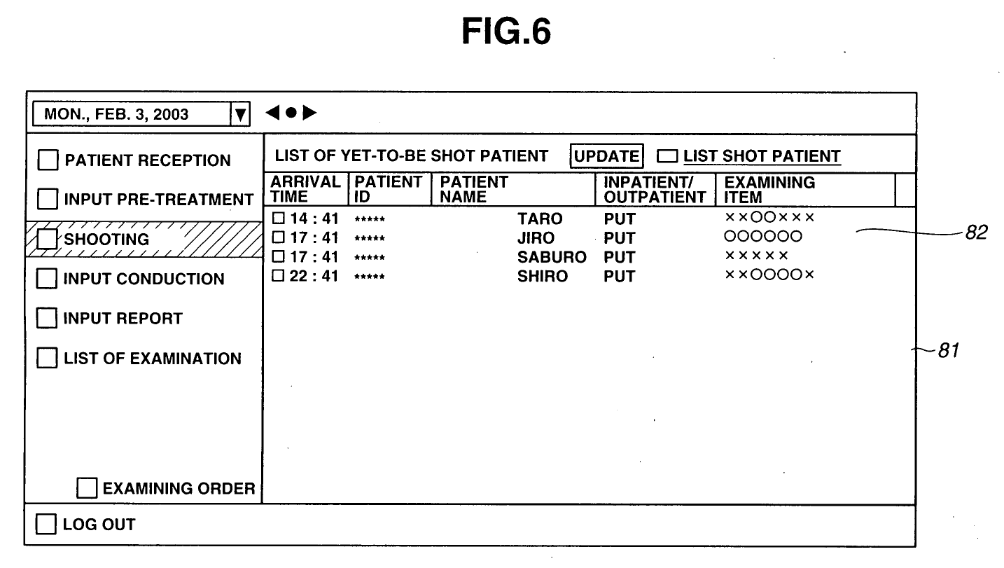

The shooting icon 61 is selected, thereby enabling starting a yet-to-be shot list screen 81 as shown in FIG. 6. The yet-to-be shot list screen 81 displays an examination list 82 for yet-to-be shot (examination list for yet-to-be shot and completion of reception is displayed by referring to an examination table 65 (refer to FIG. 4) in the database 21).

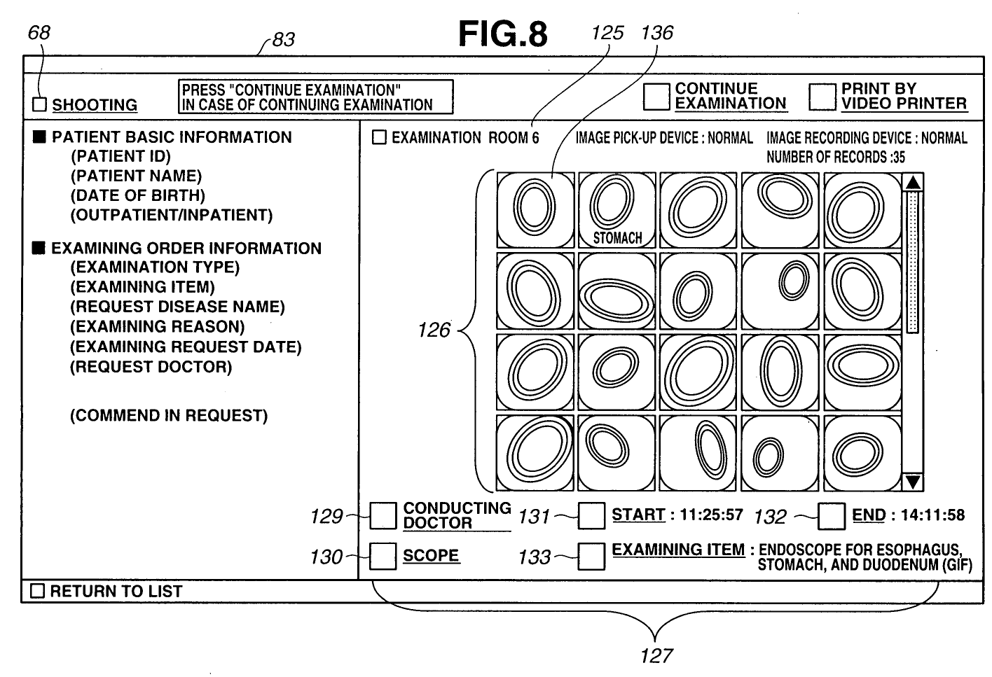

By selecting one of the yet-to-be shot list screen 81, a shooting screen 83 (refer to FIG. 8, which will be described later) for the examination is opened.

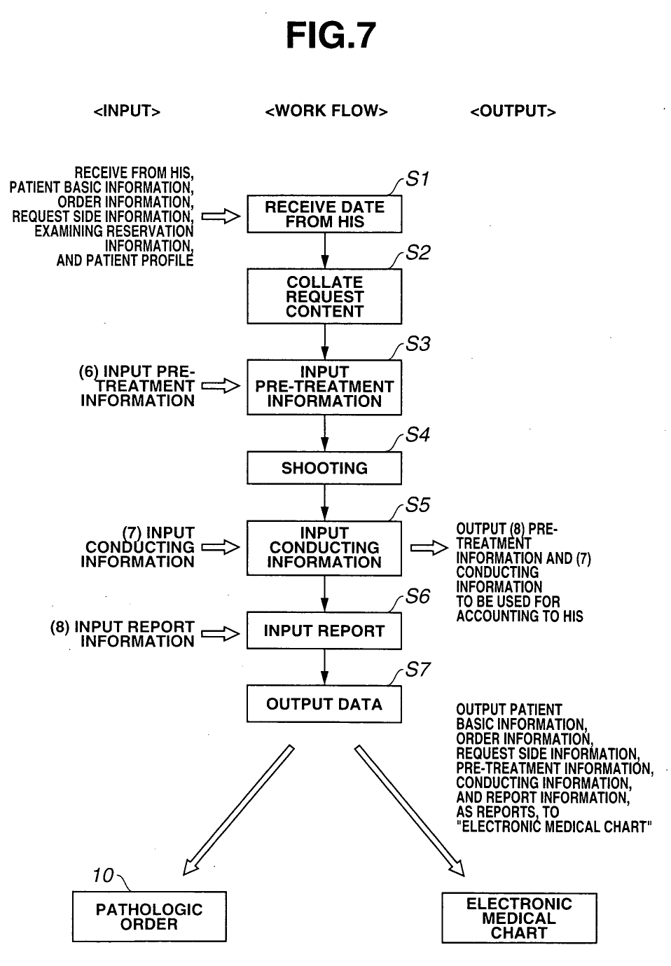

Next, the operation will be described in accordance with the examining flow. FIG. 7 shows the examining flow.

<Step S1>

The examining order is issued from another diagnostic section to the endoscope section and then the patient information (patient basic information and patient profile information) and the examining request information (order information, request side information, and examination reservation information) are sent from the HIS. Further, the examination management system receives the information.

<Step S2>

In the examination management system, the reservation is managed based on the received examination reservation information, and the examination list that is scheduled is displayed with the state of the examination. An order detail checking screen (not shown) starts in order to guide the order contents.

<Step S3>

Next, a description is given of the screen for pre-treatment of the examination such as anesthesia to the patient. A pre-treatment input screen (not shown) starts in order to input data of the pre-treatment.

<Step S4>

Next, the shooting operation in step S4 in FIG. 7 will be described.

The shooting screen 83 starts, thereby enabling capturing the image. FIG. 8 shows the shooting screen 83. The shooting screen displays: the patient information and the examining request information displayed on the left of screen; and information 125 on examination room/examining device, a shot image display area 126, and an input area 127 of examination conducting information displayed on the right of screen.

The shooting screen 83 is displayed, thereby enabling sending the patient information onto the input/examining terminal 3 arranged in the examination room. Further, the patient information is displayed on the connected electric endoscope device 14.

Furthermore, the magnetic card reader 12 is connected to the input/examining terminal 3 and therefore a magnetic card of the patient is inserted and the patient basic information is inputted. Thus, the input patient basic information is collated with those in the examination list. The assignment (pull-in) of examination to the terminals is automatically controlled.

After ending the transmission of the patient information using the examining device, the examination is ready to be conducted and the shooting operation starts by pressing a shooting button 68.

The shot image display area 126 sequentially displays reduced images 136 which are shot every release operation by the electric endoscope device 14.

In the release operation, the shot image is first captured in the compressing/decompressing device 13, and is subjected to image compression processing. The compressed image is temporarily stored in the memory in the compressing/decompressing device 13 together with the patient basic information, and is transferred into the personal computer 8 of the input/examining terminal 3. If the image transfer fails due to the disconnection of cable, the image is temporarily stored in the memory of the compressing/decompressing device 13 and therefore the shooting operation continues without interruption.

The image transferred in the personal computer 8 of the input/examining terminal 3 is temporarily stored in the hard disk 35, and is transferred into the hard disk 24 of the server 5. Here, if the image transfer fails due to the disconnection of cable, the image data is stored in the hard disk 35 of the input/examining terminal 3 and therefore the interruption of the shooting operation is also prevented.

The reduced images 136 of the shot image display area 126 are displayed by decompressing and displaying the compressed image 36 recorded to the hard disk 35.

By pressing the end button of examination of the electric endoscope device 14, the shooting operation ends, and status information of the examination managed in the examination table 65 in the database 21 enters a shooting end state.

The shooting operation in the examination is controlled by the examination DLL 29 in the main application software 27 on the input/examining terminal 3.

The shot image has a corresponding relation to the examination on the examination table 65, and pointer information indicating the storage position on an image management table 152 (refer to FIG. 4) is registered.

Further, on the shooting screen, the following information (1) to (5) is inputted in addition to the information on the image shooting.

This information is not conventionally inputted from the shooting screen, and data needs to be inputted from another screen after the examination.

According to the present invention, the information can be inputted from the shooting screen, thereby enabling improving the input efficiency and preventing an input error without failure.

(1) Conducting Doctor

An input button 129 of a conducting doctor is pressed, thereby enabling opening a window for selecting the doctor name who conducts the examination. After selecting the doctor name, the information is registered to a conducting table 153 (refer to FIG. 4) in the database 21. Since the examination is often conducted by a plurality of members, the plurality of conducting doctors can be selected.

(2) Scope in Use

A scope input button 130 is pressed, thereby enabling opening a window for selecting a scope used for examination (a selecting candidate is obtained from a scope master 156 (refer to FIG. 4) in the database 21, and is displayed). After selecting the using scope, the information is registered to an examining scope table 157 (refer to FIG. 4) in the database 21. The scope may be exchanged during the operation and therefore a plurality of scopes can be registered.

(3) Shooting Start Time

The time for opening the shooting screen is displayed beside a start button 131. The start button 131 is pressed, thereby enabling opening a window for inputting the shooting start time and thus the time can be changed. The shooting start time registered in the examination table 65 in the database 21.

(4) Shooting End Time

An end button of the examination on the electric endoscope device 14 is pressed, thereby enabling displaying the time for ending the examination beside an end button 132. Also, the end button 132 is pressed, thereby enabling opening a window for inputting the shooting end time and thus the shooting end time can be changed. The shooting end time is registered in the examination table 65 in the database 21.

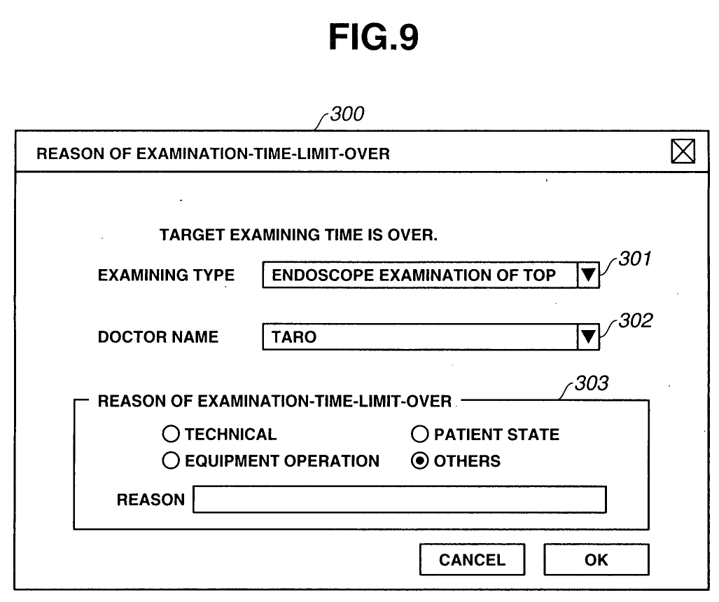

Further, at the timing for registering the shooting end time, the actual examining time starting from the shooting start time is calculated, and is compared with an examining target time of an examining target master 158 in the database 21. When the difference between the actual examining time and the examining target time, a screen 300 of examination-time-limit-over reason for inputting the difference reason is displayed (refer to FIG. 9, which will be described later).

(5) Examining Item

An examining item button 133 is pressed, thereby enabling opening a window for selecting and inputting the examining item. The examining item is selected, thereby enabling registering the selected examining item in the examination table 65 in the database 21.

The difference is caused between the examining item designated at the examination order time and the examining item that is actually conducted. In consideration of the difference, the actually-conducted examining item is selected on the shooting screen, and is registered (in the case of actually conducting the treatment because the lesion portion is found, though the screening is predetermined at the order timing).

The (3) shooting start time and (4) shooting end time are automatically registered, assuming that the patient ID is inputted from the electric endoscope device 14 without opening the shooting screen and the patient is examined.

Under the following control, the registration and control operations of the times are executed.

Shooting Start Time

Case 1: The time for opening the shooting screen is registered.

Case 2: The more accurate time which is to be recorded after opening the shooting screen is inputted by using the start button 131.

Case 3: The time for recording a first image is registered in the case of conducting the shooting operation without opening the shooting screen.

Shooting End Time

Case 1: The time for ending the examination or the time for turning-off the power of the observing device is registered from the electric endoscope device 14.

Case 2: The more accurate time which is to be recorded after opening the shooting screen is inputted by using the end button 132, not starting from the processing of Case 1.

Case 3: The same processing as that in Case 1 is performed in the case of conducting the shooting operation without opening the shooting screen.

Case 4: After registering the time, the actual examining time starting from the shooting start time is calculated, and is calculated and compared with the pre-registered examining target time. When the actual examining time is over the examining target time, the screen 300 of examination-time-limit-over reason for inputting the difference reason is displayed.

When the actual examining time is over the examining target time, the screen 300 of examination-time-limit-over reason starts. FIG. 9 shows the screen 300 of examination-time-limit-over reason.

From the screen 300 of examination-time-limit-over reason, an examination type 301, a doctor name 302, and an examination-time-limit-over reason 303 are inputted, and are registered to a table 159 of examination-time-limit-over reason (refer to FIG. 4) in the database 21.

The input operation of the examination-time-limit-over reason is controlled under the following conditions.

(1) The input operation is possible under such a condition that the examining target time has already been registered.

(2) The input operation is possible under such a condition that the examining start time and the examining end time are registered in the shooting operation.

(3) The examining target time is compared with the examining time and then the examining time is over the examining target time.

The conditions are set to collect time factors for examination.

<Step S5>

In step S5 in FIG. 7, a conducting input screen (not shown) starts, thereby enabling inputting the conducting information.

<Step S6>

In step S6 in FIG. 7, the patient information and the examining request information are displayed on a report input screen (not shown). In addition, the contents of the examining report (findings and treatment, diagnosis, and comment) is registered on the right.

<Step S7>

The report information is referred to in the system of the endoscope section, and is sent to the HIS via the LAN by the GW 1. Thus, the report information is referred to in the electronic medical chart system of the HIS.

Further, in addition to the registration and transmission of report, pathological order is issued (in step S10) based on the report information.

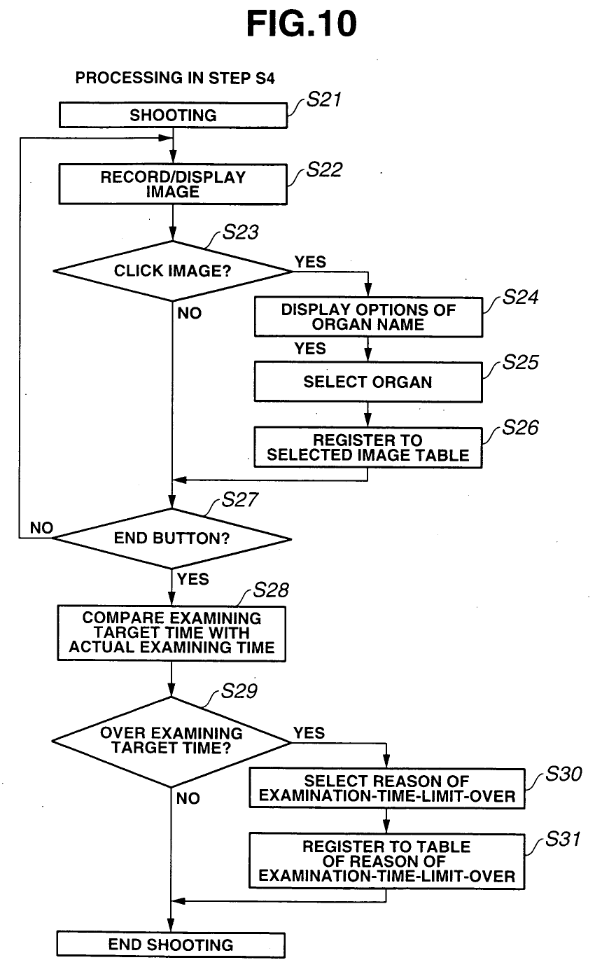

FIG. 10 is flowchart additionally having a detailed flow of picking-up the above-mentioned processing in step S4 from the work flow shown in FIG. 7 and of steps when the examining time is over the examining target time.

The time factors for examination are inputted on the shooting screen 83 in the description of step S4 and then the operation thereof will be described with reference to FIG. 10.

The shooting screen 83 starts, and the image is captured in step S21. In step S22, reduced images 136 are sequentially displayed on the screen. In step S23, a desired one of the reduced images 136 is clicked by the mouse. In step S24, an optional window of the organ names is displayed. In step S25, the proper organ name is selected from the optional window. In step S26, data on the organ name and an image number are registered to a selected image table 160 (refer to FIG. 4) in the database 21. Here, before pressing the examining end button, the image is selected as an example. However, in step S27, the end button 132 is pressed and the selection and input may be repeated on the shooting screen 83 just after the end of shooting operation (in steps S21 to S27).

The shooting screen 83 starts and then the time for opening the shooting screen is displayed beside the start button 131. The start button 131 is pressed and thus a window for inputting the shooting start time and the time can be changed. The end button 132 is pressed and then the time for ending the examination is displayed beside the end button 132. The end button 132 is pressed and thus a window for inputting the shooting end time is opened and the time can be changed.

In step S27, the end button 132 is pressed. Then, in step S28, the actual examining time starting from the shooting start time is calculated and then is compared with the examining target times which have already been registered of the examining target master 158 in the database 21.

In step S29, when the examining time is over the examining target time, the screen 300 of examination-time-limit-over reason for inputting the difference reason is displayed. In step S30, the examination-time-limit-over reason is inputted. Then, in step S31, the reason of examination-time-limit-over is registered in the table 159 of examination-time-limit-over reason in the database 21. The examination-time-limit-over reason which is inputted/displayed can be changed.

Those control operations are performed in the examination DLL 29 of the main application software 27 on the search terminal 4 (or input/examining terminal 3). The display information is called from the database 21. The edited and inputted information is registered to the database 21.

Next, a description is given of the function for outputting the list of examination-time-limit-over by the statistics and history function.

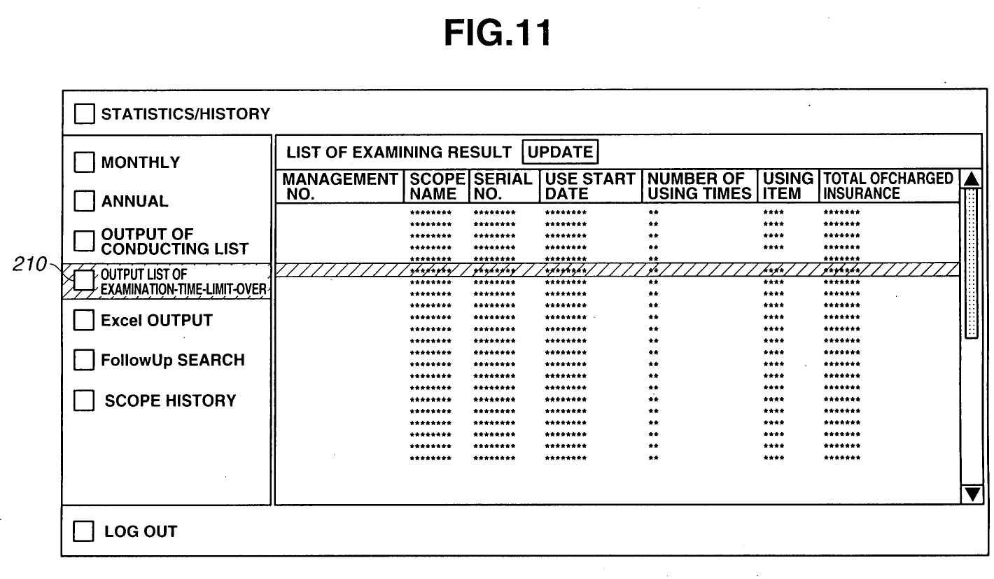

FIG. 11 is a diagram showing a statistics and history screen which starts when the statistics and history icon 54 is selected for log-in on the system start/end screen 101. An icon 210 for outputting the list of examination-time-limit-over is prepared on the left of screen, and a function for displaying the list of examination-time-limit-over.

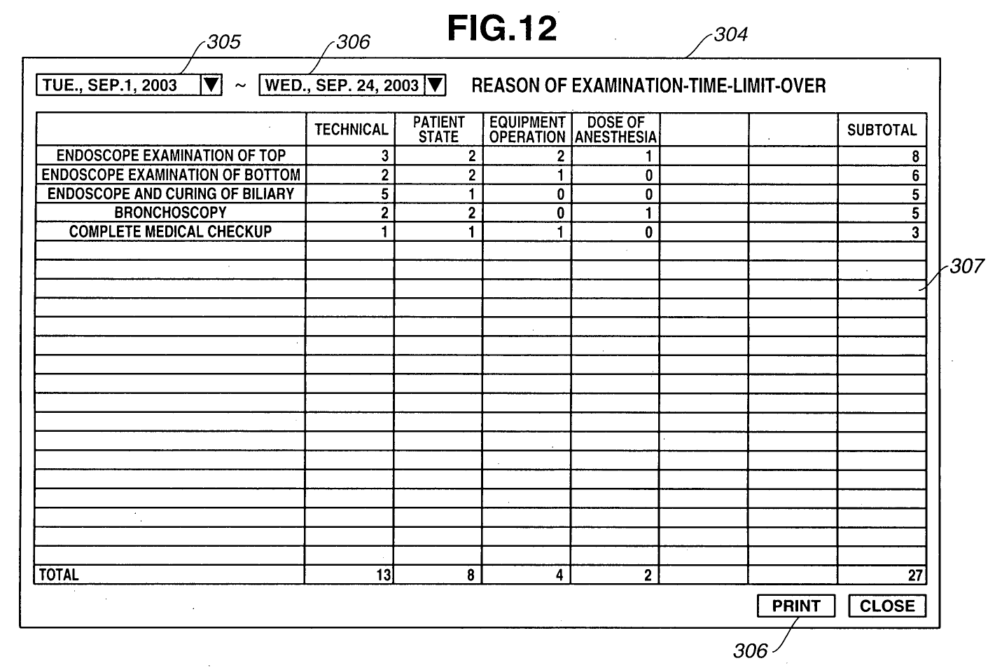

The icon 210 for outputting the list of examination-time-limit-over is selected and then a screen 304 of the list of examination-time-limit-over reason is displayed. FIG. 12 shows the screen 304 of the list of examination-time-limit-over reason.

On the screen 304 of the list of examination-time-limit-over reason, the search term for collecting the examination-time-limit-over reason is inputted. The search start date and the search end date are inputted on a search start date column 305 and a search end date column 306, thereby enabling collecting the examination-time-limit-over reason within the search term and displaying a collected result 307. A print button 308 is pressed, thereby enabling printing the collected result 307.

On the screen 304 of the list of examination-time-limit-over reason, the actual examining time is compared with the examining target time on the shooting screen 83 and the difference reason to the examining target time is registered. Therefore, the examination-time-limit-over reason is collected and the collected result 307 is calculated.

Next, a description is given of a master setting function serving as a management function.

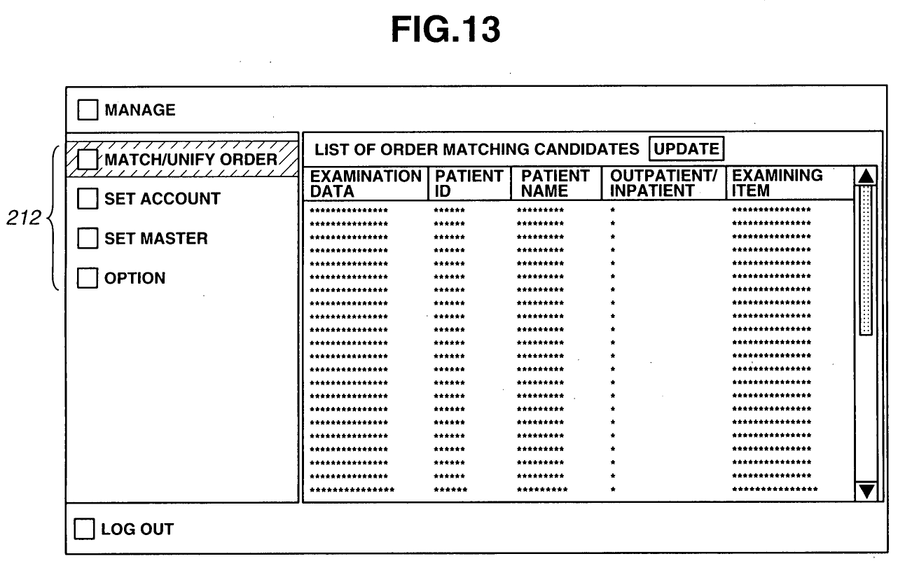

FIG. 13 is a diagram showing a management function screen which starts upon selecting a management function icon 55 for log-in on the system start/end screen 101. Icons 212 for selecting the management functions are provided on the left of screen. The master setting button is pressed, thereby enabling operating the master setting function.

The master setting function enables the registration, change, and withdrawal of the examining target time or the like every examination type as well as the type of master examination and the examining item. Further, the master setting function accesses the contents of the examining target master 158 in the database 21.

As described above, according to the embodiment, the examining target time is set in advance. Therefore, the actual examining time can be compared with the examining target time on the shooting screen and the difference factor is inputted on the screen for inputting the examination-time-limit-over reason. Thus, the information on the medical action is accurately collected.

Further, the information inputted on the screen for inputting the examination-time-limit-over reason is displayed on the screen of the list of examination-time-limit-over reason. Consequently, the solution to eliminate the time difference factor is accurately evaluated.

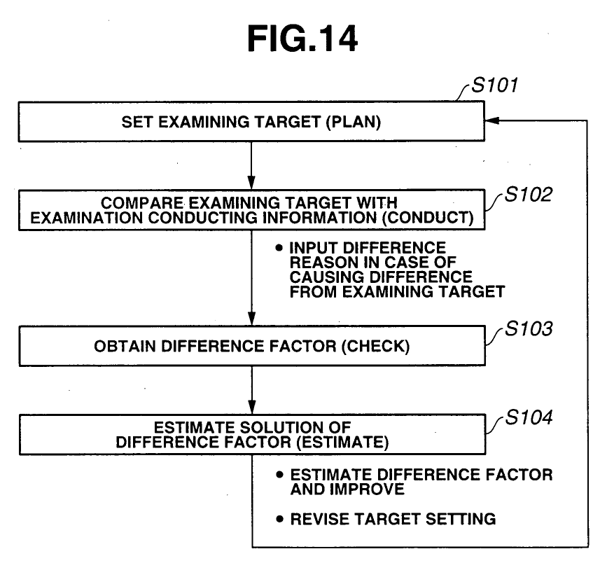

FIG. 14 is a flowchart for explaining the flow of estimating the factor of an examination-time-limit-over according to the embodiment. The information at the timing for the generating the medical action is collected as the collecting information according to the embodiment. The examination-time-limit-over reason for the same type of examination is clearly and easily obtained and analyzed. The medical service member grasps the difference reason and easily performs the improvement.

That is, referring to FIG. 14, in step S101, the examining target is set. In step S102, the information is inputted at the timing for generating the actual medical action and the examination conducting information is compared with the examining target. In step S103, information on the well-grounded difference is obtained. In step S104, the solution of the difference factor is estimated, the medical service member repeats the review and check of the operation, and thus the operation is improved.

The present invention is not limited to the above-mentioned embodiment and can be modified without departing from the essentials of the present invention.

Further, any embodiment which is obtained by partly combining the embodiment belongs to the present invention.

In this invention, it is apparent that working modes different in a wide range can be formed on this basis of this invention without departing form the spirit and scope of the invention. This invention is not restricted by any specific embodiment except being limited by the appended claims.

1. An examination management system comprising:
an examining information input unit which inputs information on examination;
an examining information recording unit which records the information on the examination that is inputted by the examining information input unit;
an examining target information storing unit which stores examining target information that is preset, corresponding to the information on the examination;
an information comparing unit which compares information obtained based on conducting information on the examination upon conducting the examination with the information that is stored in the examining target information storing unit corresponding to the information on the examination recorded to the examining information recording unit;
a comparing result item input unit which inputs an item on the comparing result by the information comparing unit;
a comparing result item input control unit which permits the operation of the comparing result item input unit when a predetermined condition is satisfied; and
a comparing result item recording unit which records the item on the comparing result upon inputting the item on the comparing result to the comparing result item input unit.

2. An examination management system according to claim 1, wherein the information obtained based on the conducting information on the examination upon conducting the examination includes an examining time which is obtained based on an examining start time and an examining end time.

3. An examination management system according to claim 2, wherein the examining target information that is preset includes an examining target time that is preset, corresponding to the information on the examination.

4. An examination management system according to claim 3, wherein the item on the comparing result by the information comparing unit includes a reason item on the difference between the examining time and the examining target time.

5. An examination management system according to claim 4, wherein the predetermined condition to be satisfied is as follows: the examining target time that is preset is stored in the examining target information storing unit upon satisfying the predetermined condition, the examining start time and the examining end time are recorded to the examining information recording unit, and the examining time is over the examining target time is included.

6. An examination management method comprising:
a step of recording inputted information on an examination;
an information comparing step of comparing examining target information that is preset corresponding to the inputted information on the examination upon conducting a predetermined examination with information obtained based on conducting information on the examination;
a step of permitting the input of an item on the comparing result in the information comparing step upon satisfying a predetermined condition; and
a step of recording the input item on the comparing result, which is permitted by satisfying the predetermined condition.

7. An examination management method according to claim 6, the information obtained based on the conducting information upon conducting the examination includes an examining time obtained based on an examining start time and an examining end time.

8. An examination management method according to claim 7, wherein the examining target information that is preset includes an examining target time that is preset corresponding to the information on the examination.

9. An examination management method according to claim 8, wherein the input item on the comparing result includes a reason item on the difference between the examining time and the examining target time.

10. An examination management system according to claim 9, wherein the information recorded upon satisfying the predetermined condition includes the examining target time that is preset, the examining start time, and the examining end time.

11. An examination management system comprising:
an examining information input unit which inputs information on an examination;
an examining information recording unit which records the information on the examination that is inputted by the examining information input unit;
an examining target time storing unit which stores an examining target time that is preset, corresponding to the information on the examination;
an information comparing unit which compares an examining time obtained based on conducting information on the examination with upon conducting the examination with the examining target time that is stored in the examining target time storing unit corresponding to the information on the examination recorded to the examining information recording unit;
a comparing result item input unit which inputs an item on the comparing result by the information comparing unit;
a comparing result item input control unit which permits the operation of the comparing result item input unit, only when predetermined condition is satisfied; and
a comparing result item recording unit which records the item on the comparing result upon inputting the item on the comparing result to the comparing result item input unit.
